(19) United States
(12) Patent Application Publication
(10) Pub. No.: US 2017/0136845 A1
(43) Pub. Date: May 18, 2017

(54) BUS AIR-CONDITIONING ARRANGEMENT, AND METHOD FOR PRODUCING SAME

(71) Applicant: GEA Bock GmbH, Frickenhausen (DE)

(72) Inventor: Wolfgang SANDKÖTTER, Frickenhausen (DE)

(21) Appl. No.: 15/310,341

(22) PCT Filed: May 13, 2015
(86) PCT No.: PCT/EP2015/000987

§ 371 Date: Nov. 10, 2016

(30) Foreign Application Priority Data
May 14, 2014 (DE) 10 2014 006 965.6

(51) Int. Cl. B60H 1/00; H02P 9/30; H02P 27/06; F25B 31/02; H02K 7/10; H02K 7/14; B60L 1/00; B60H 1/32; H02K 7/18

(52) U.S. Cl. CPC B60H 1/00371; B60H 1/00428; B60H 1/3222; H02P 9/302; H02P 27/06; H02K 7/1815; H02K 7/1008; H02K 7/14; B60L 1/003; F25B 31/026; B60H 2001/3292

(57) ABSTRACT

A bus air-conditioning arrangement with a compressor for compressing refrigerant, wherein the compressor has an electric motor and a compression device, which is driven by the electric motor, for compressing refrigerant, wherein the bus air-conditioning system furthermore has an electric generator which has dimensions such that said generator can be fitted in a receiving space, which is provided for a compressor and which is arranged in a driving motor of a bus or in an installation space for the driving motor of the bus, wherein the generator is driveable by the driving motor, in particular by means of a belt drive, and wherein the electric motor of the compressor is driveable by electrical power which the generator generates, and a method for producing same.

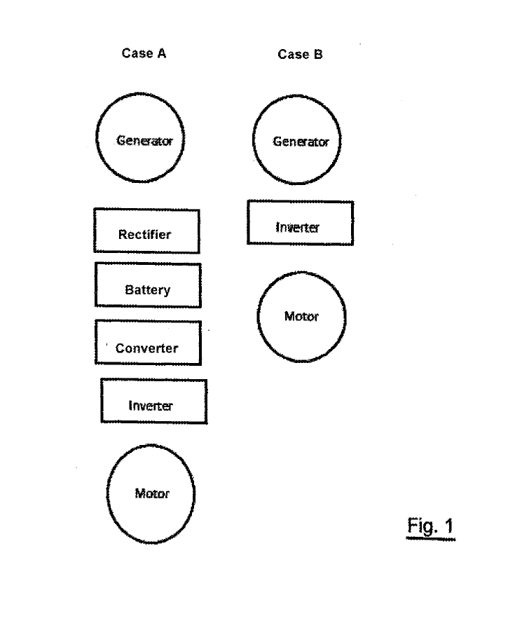

The present invention relates to a bus air-conditioning arrangement as claimed in the preamble of patent claim 1, and also to a method for producing a bus air-conditioning arrangement of this kind as claimed in patent claim 6. The present invention further relates to a bus comprising a corresponding bus air-conditioning arrangement.

Bus air-conditioning arrangements and diesel engine-operated buses comprising bus air-conditioning arrangements of this kind have long been known in the prior art. Said bus air-conditioning arrangements have a compressor for compressing refrigerant, which compressor is arranged in a corresponding accommodation space in a diesel engine or in an installation space for the diesel engine of the bus and which compressor is connected to the diesel engine by means of a belt drive and is driven by said belt drive. Air-conditioning systems of this kind further generally have a condenser, an expansion element in the form of an expansion valve, and an evaporator for controlling the climate in the bus.

Owing to the arrangement of the compressor, it is subject to various interfering influences, for example vibrations, heat etc. This can lead to leakages from the compressor or, in particular, from connections of said compressor by means of which the refrigerant enters the refrigerant circuit of the arrangement. Furthermore, a compressor has to be designed such that it provides a clearly noticeable refrigeration capacity, for example at least 50% of the maximum capacity of the arrangement, even at an idling rotation speed of the diesel engine. To this end, the compressor generally has to be designed to be excessively powerful, wherein the delivery capacity of the compressor has to be correspondingly limited, in particular at high rotation speeds of the diesel engine.

The object of the present invention is to specify a bus air-conditioning arrangement in which a compressor can be dimensioned to be as small as possible, wherein only extremely minor structural interventions are intended to be required, in particular in the bus and in a diesel engine of said bus. A further object of the present invention is to specify a method for producing said bus air-conditioning arrangement. The concept of the invention also includes a bus comprising a corresponding bus air-conditioning arrangement.

According to the invention, this object is achieved by a bus air-conditioning arrangement as claimed in patent claim 1. The method aspect of the object is achieved by a method as claimed in claim 6.

Accordingly, the apparatus aspect of the present object is achieved by a bus air-conditioning arrangement comprising a compressor for compressing refrigerant, wherein the compressor has an electric motor and also a compression apparatus, which is driven by the electric motor, for compressing refrigerant. The bus air-conditioning system further has an electrical generator which is dimensioned such that it can be fitted in an accommodation space which is provided for a compressor and which is arranged in a drive motor, particularly an internal combustion engine, further particularly a diesel engine, of a bus or in an installation space for the drive motor of the bus. The generator can be driven by the drive motor, in particular by means of a belt drive, wherein furthermore the electric motor of the compressor can be driven by electrical power which the generator generates.

As a result, the compressor can be arranged outside the diesel engine and also outside the installation space for the drive motor. One possible location for arrangement is, for example, the roof of the bus, in particular if a large proportion of the remaining constituent parts of the bus air-conditioning arrangement are arranged there, for example in the form of an air-conditioning module which is to be mounted on the roof.

The method aspect of the object is achieved by a method for producing a bus air-conditioning system which has a compressor for compressing refrigerant, which method comprises the following steps:
arranging or fitting an electrical generator in an accommodation space which is arranged in a drive motor, particularly an internal combustion engine, further particularly a diesel engine, of a bus or an installation space for the drive motor of the bus, which accommodation space is dimensioned for accommodating a compressor, wherein the generator is dimensioned such that it can be fitted in the accommodation space;
arranging or fitting a compressor, which has an electric motor and also a compression apparatus, which is driven by the electric motor, for compressing refrigerant, outside the drive motor of the bus and outside the installation space for the drive motor of the bus;
wherein the compressor is driven by the electrical power which is generated by the generator.

Further optional features of the invention are specified in the dependent claims, and also the following more detailed description of possible embodiments, which description also makes reference to the single attached FIGURE. The described respective features can be realized individually or in any desired combinations. The attached drawing shows:

a schematic illustration of a structure of a bus air-conditioning arrangement.

In one possible embodiment, a generator, which is attached to the diesel engine, is arranged in an accommodation space, which is arranged in a drive motor (which is in the form of an internal combustion engine which, in turn, is in the form of a diesel engine in the described embodiment) of a bus or an installation space for the drive motor, more precisely the diesel engine of the bus, and which is dimensioned to accommodate a compressor, instead of a compressor in the case of a bus air-conditioning arrangement. It should be noted at this point that the drive motor can, for example, also be a gas engine or a petrol engine in alternative embodiments. The generator preferably has the same connection dimensions as compressors which are conventional today, but at least is dimensioned such that it can be accommodated in said accommodation space. Therefore, it is possible to incorporate this generator in any bus which has a compressor or is intended to be equipped with a compressor. In the embodiment described at present, the generator is designed for a customary voltage, for example 400 V at 100 Hz and 3000 revolutions per minute.

An air-conditioning system comprising one or (in alternative embodiments) a plurality of electrically driven compressors is operated using the electric power which is generated by the generator. As an alternative, a plurality of independent air-conditioning units, which can each have one or more compressors, can also be operated.

The compressor is of semi-hermetic design; of hermetic design in alternative embodiments. The compressor is operated such that it provides precisely the refrigeration capacity which is required by the vehicle at that time. To this end, it has to be possible to subject the compressor to closed-loop control; a rotation speed closed-loop control system comprising an inverter is provided for this purpose.

The generator can be designed such that it outputs sufficient power in order to cool down the bus even at the idling rotation speed of the diesel engine. The design of said generator can preferably be such that, for example, 50% of the maximum capacity is available even at the idling rotation speed, whereby the refrigeration capacity of the vehicle air-conditioning system can also already be 50%, and therefore is far superior to a conventional system comprising a compressor which is driven by the diesel engine. In the case of a compressor which is driven by the diesel engine, usually displacement machines, the refrigeration capacity primarily changes in proportion to the rotation speed. In order to thus achieve a sufficient refrigeration capacity at the idling speed of the engine, the compressor has to be dimensioned to be correspondingly large, this leading to an excessively high refrigeration capacity at high rotation speeds which, in turn, require closed-loop control of the compressor. Closed-loop control is lossy owing to the linear characteristics of a displacement compressor.

A generator on the other hand can be subjected to closed-loop control in a substantially more efficient manner and over a broader band. For example, the rotation speed of a generator can be raised in relation to a compressor and, if the rated capacity and the rated rotation speed are exceeded, the generator can be kept at a constant power, with considerably fewer losses than a compressor.

Therefore, according to the described possible embodiment, it is proposed to subject the generator, which can be designed as an asynchronous machine or as a synchronous machine, and also as a permanent-magnet (PM) machine, to closed-loop control at the output end. An electronic control unit which feeds the variable (rotation speed-dependent) output voltage and frequency of the generator to an intermediate circuit is provided for this purpose. In said intermediate circuit, said output voltage and frequency are standardized and, depending on the requirement of the air-conditioning unit, converted into a suitable output voltage and frequency.

In the described embodiment, the two closed-loop control systems (of the compressor and of the generator) are combined in a single closed-loop control element, specifically in an inverter which can be operated at variable frequency at the input end and output end. As an alternative, it is possible to separate the two closed-loop control systems and design them as two separate closed-loop control systems.

A relatively simple design of a bus air-conditioning arrangement or an air-conditioning unit comprising a generator is illustrated as case B in the attached FIGURE. Instead of a compressor with a magnetic coupling and a belt drive, a generator which is driven by the belt, an inverter and an electrically operated compressor are provided in said case. This solution corresponds to a “drop in” solution which can be applied to all existing vehicles comprising standard compressors.

The design according to the invention has various advantages:
the electrical compressor can be integrated directly into the refrigeration unit. Therefore, the system is more compact and has shorter line lengths and less refrigerant filling;
the electrical compressor is operated in accordance with requirements and can therefore save up to 70% of the energy, even though the two electrical machines are lossy;
the electrical machines can be designed with degrees of efficiency of 0.9 or better, this being the prior art today and being considerably above 24 V generators typical in current vehicles;
the electrical compressor can be of hermetic or semi-hermetic design and does not require a shaft seal. Therefore, the risk of leakage is considerably reduced;
the operating and functional conditions of the compressor are significantly improved and are similar to those in stationary systems by virtue of being decoupled from the diesel engine and its surrounding area;
the need for servicing is reduced and the reliability is increased owing to the compact, closed system and the ability to operate as required;
the reliability, leaktightness and closed-loop controllability are now comparable with a stationary system, CO₂ can also be used as refrigerant as standard for the new system;
CO₂ then provides a sustainable and environmentally friendly solution;
a system of this kind—specifically with CO₂—can also be used to outstanding effect for heating the vehicle in winter.
   Therefore, it is further proposed to use CO₂ as refrigerant.

An extended system, illustrated under “Case A” in the FIGURE, can also be used in addition to the “drop in” solution. In addition to the generator and the motor of the compressor, this embodiment also has a rectifier, a battery, a converter and an inverter. Buffer storage of electrical power in the battery would allow the refrigeration unit to operate even in case of a stoppage of the diesel engine. Furthermore, further loads could be connected to the efficient voltage source. For example, it would be feasible to draw the current from the new high-voltage circuit, that is to say from the generator which is also provided for driving the compressor, specifically preferably via a rectifier/voltage converter, instead of from the 24 V generators which are customary today and have degrees of efficiency of approximately 50%.

The present invention also comprises a method for producing a bus air-conditioning system which has a compressor for compressing refrigerant, which method comprises the following steps:
arranging or fitting an electrical generator in an accommodation space which is arranged in a diesel engine of a bus or an installation space for the diesel engine of the bus, which accommodation space is dimensioned for accommodating a compressor, wherein the generator is dimensioned such that it can be fitted in the accommodation space;
arranging or fitting a compressor, which has an electric motor and also a compression apparatus, which is driven by the electric motor, for compressing refrigerant, outside the diesel engine of the bus and outside the installation space for the diesel engine of the bus;
wherein the compressor is driven by the electrical power which is generated by the generator.

One possible refinement of the method provides that the rotation speed of the compressor can be subjected to open-loop control or can be subjected to closed-loop control by means of a compressor rotation speed open-loop control or closed-loop control apparatus which, in particular, has an inverter, and/or that an output voltage and an output frequency of the generator can be subjected to open-loop control or can be subjected to closed-loop control.

A further possible refinement of the method provides that the rotation speed of the compressor and an output voltage and an output frequency of the generator can be subjected to open-loop control or can be subjected to closed-loop control by means of a single inverter.

The concept of the invention also includes a bus comprising an above-described bus air-conditioning arrangement.

The concept of the invention further includes: a method for modifying a bus air-conditioning system which has an existing compressor for compressing refrigerant, wherein the existing compressor is arranged in an accommodation space, which is dimensioned to accommodate the compressor, in a diesel engine of a bus, which method comprises the following steps:
removing the existing compressor from the accommodation space;
arranging or fitting an electrical generator in an accommodation space which is arranged in a diesel engine of a bus and which is dimensioned for accommodating a compressor, wherein the compressor is dimensioned in such a way that it can be fitted in the accommodation space;
arranging or fitting a compressor, which has an electric motor and also a compression apparatus, which is driven by the electric motor, for compressing refrigerant, outside the diesel engine of the bus;
wherein the compressor is driven by the electrical power which is generated by the generator.

Even though the invention is described on the basis of embodiments with fixed combinations of features, said invention however also comprises the further feasible advantageous combinations as specified in particular, but not exhaustively, by the dependent claims. All of the features disclosed in the application documents are claimed as being essential to the invention insofar as they are novel, individually or in combination, over the prior art.

1. A bus air-conditioning arrangement comprising a compressor for compressing refrigerant, wherein the compressor has an electric motor and also a compression apparatus, which is driven by the electric motor, for compressing refrigerant, wherein the bus air-conditioning system further has an electrical generator which is dimensioned such that it can be fitted in an accommodation space which is provided for a compressor and which is arranged in a drive motor of a bus or in an installation space for the drive motor of the bus, wherein the generator can be driven by the drive motor, in particular by means of a belt drive, and wherein the electric motor of the compressor can be driven by electrical power which the generator generates.

2. The arrangement as claimed in claim 1, wherein the compressor has a compressor rotation speed openloop control or closed-loop control apparatus which has, in particular, an inverter.

3. The arrangement as claimed in claim 1, wherein the generator has an electronic control unit which controls an output voltage and an output frequency of the generator.

4. The arrangement as claimed in claim 3, wherein the compressor rotation speed open-loop control or closed-loop control apparatus and the electronic control unit of the generator are in the form of inverters which can be operated at variable frequency at the input end and output end.

5. The arrangement as claimed in claim 3, wherein the compressor is a hermetic or a semi-hermetic compressor.

6. A method for producing a bus air-conditioning system which has a compressor for compressing refrigerant, comprising
arranging or fitting an electrical generator in an accommodation space which is arranged in a drive motor of a bus or an installation space for the drive motor of the bus, which accommodation space is dimensioned for accommodating a compressor, wherein the generator is dimensioned such that it can be fitted in the accommodation space;
arranging or fitting a compressor, which has an electric motor and also a compression apparatus, which is driven by the electric motor, for compressing refrigerant, outside the drive motor of the bus and outside the installation space for the drive motor of the bus;
wherein the compressor is driven by the electrical power which is generated by the generator.

7. The method as claimed in claim 6, wherein the rotation speed of the compressor can be subjected to open-loop control or can be subjected to closed-loop control by means of a compressor rotation speed openloop control or closed-loop control apparatus which, in particular, has an inverter, and/or in that an output voltage and an output frequency of the generator can be subjected to open-loop control or can be subjected to closed-loop control.

8. The method as claimed in claim 6, wherein the rotation speed of the compressor and an output voltage and an output frequency of the generator can be subjected to open-loop control or can be subjected to closed-loop control by means of a single inverter.

9. A bus comprising a bus air-conditioning arrangement as claimed in claim 1.
